(19) United States
(12) Patent Application Publication
(10) Pub. No.: US 2015/0346645 A1
(43) Pub. Date: Dec. 3, 2015

(54) IMAGE FORMING APPARATUS

(71) Applicant: CANON KABUSHIKI KAISHA, Tokyo (JP)

(72) Inventor: Yutaka Kakehi, Kashiwa-shi (JP)

(21) Appl. No.: 14/718,780

(22) Filed: May 21, 2015

(30) Foreign Application Priority Data
May 29, 2014 (JP) 2014-111487
Apr. 23, 2015 (JP) 2015-088457

(51) Int. Cl. G03G 15/01

(52) U.S. Cl. CPC G03G 15/1605; G03G 15/80

(57) ABSTRACT

The image forming apparatus is equipped with an intermediate transfer belt, a toner image forming portion, a biasing member, a support roller, a rotator, a power supply, a guide portion, and a press member. The press member is arranged upstream from the nip portion in the direction of rotation of the intermediate transfer belt and adjacent to the nip portion, and elastically presses an inner side surface of the intermediate transfer belt. A press force by which the press member presses the intermediate transfer belt is greater than a tension that the biasing member applies to the intermediate transfer belt.

### BACKGROUND OF THE INVENTION

1. Field of the Invention

The present invention relates to an image forming apparatus having an intermediate transfer belt.

2. Description of the Related Art

Conventionally, intermediate transfer-type image forming apparatuses are used widely as image forming apparatuses. In such intermediate transfer-type image forming apparatus, a recording medium is nipped and conveyed through a nip portion between an intermediate transfer belt supported by a secondary transfer inner roller and a secondary transfer roller, and transfer voltage is applied to the secondary transfer roller at the nip portion, to thereby transfer a toner image formed on the intermediate transfer belt to a recording medium.

In the intermediate transfer-type image forming apparatus, when voltage is applied to the secondary transfer roller to have the toner image transferred from the intermediate transfer belt to the recording medium, it is preferable to overlay the recording medium to the intermediate transfer belt at a position upstream from the nip portion in a direction of rotation of the intermediate transfer belt and have the medium conveyed to the nip portion. This arrangement is preferable since a potential difference between the intermediate transfer belt and the recording medium can be maintained small and image defection caused by the discharge between the two components can be reduced.

For example, in an intermediate transfer-type image forming apparatus taught in Japanese Patent Application Laid-Open No. 2002-82543, a plate-like member having high stiffness formed of hard resin or metal is arranged upstream from the nip portion in the direction of rotation of the intermediate transfer belt, forming an intermediate transfer belt surface that is parallel to the direction in which the recording medium is conveyed and upstream in the direction of rotation of the intermediate transfer belt, so as to overlay the recording medium on the intermediate transfer belt.

In the above-described image forming apparatus, it has been found that if the recording medium is thick and has high stiffness, discharge tends to occur when the toner image is transferred to the rear end portion of the recording medium, by which image defection is caused. Especially when a guide member of the recording medium is arranged such that the recording medium is overlaid to the intermediate transfer belt between the position where the plate-like member is in contact with the intermediate transfer belt and the nip portion, image defection caused by discharge tends to occur.

### SUMMARY OF THE INVENTION

According to one aspect of the invention, an image forming apparatus includes an intermediate transfer belt; a toner image forming portion configured to form a toner image on the intermediate transfer belt; a biasing member configured to bias an extension roller on which the intermediate transfer belt is extended toward the intermediate transfer belt and applying tension to the intermediate transfer belt; a support roller in contact with an inner side surface of the intermediate transfer belt, configured to support the intermediate transfer belt; a rotator configured to form a nip portion by nipping the intermediate transfer belt with the support roller; a power supply configured to apply voltage between the rotator and the support roller, and to transfer a toner image at the nip portion to a recording medium conveyed through the nip portion; a guide portion, disposed upstream from the nip portion in a direction in which the recording medium is conveyed, configured to guide the recording medium to the nip portion; and a press member arranged upstream and adjacent to the nip portion in a direction of rotation of the intermediate transfer belt from the nip portion, configured to elastically press an inner side surface of the intermediate transfer belt, a press force of the press member for the intermediate transfer belt being greater than the tension that the biasing member applies to the intermediate transfer belt.

Further features of the present invention will become apparent from the following description of exemplary embodiments with reference to the attached drawings.

### BRIEF DESCRIPTION OF THE DRAWINGS

FIG. 1 is an explanatory view illustrating a configuration of an image forming apparatus according to a first embodiment.

FIG. 2A is an explanatory view illustrating a state where a recording medium is guided by a guide portion of a conventional image forming apparatus.

FIG. 2B is an explanatory view illustrating a state where a recording medium has passed through the guide portion of the conventional image forming apparatus.

FIG. 3 is an explanatory view illustrating an arrangement of a backup sheet according to the first embodiment.

FIG. 4 is a perspective view illustrating the state in which a backup sheet is attached according to the first embodiment.

FIG. 5 is an explanatory view illustrating a relationship between amount of displacement and press force of each thickness of the backup sheet according to the first embodiment.

FIG. 6 is an explanatory view illustrating the arrangement of a backup roller according to a second embodiment.

### DESCRIPTION OF THE EMBODIMENTS

Now, the preferred embodiments for carrying out the present invention will be described in detail with reference to the drawings.

### First Embodiment

### Image Forming Apparatus

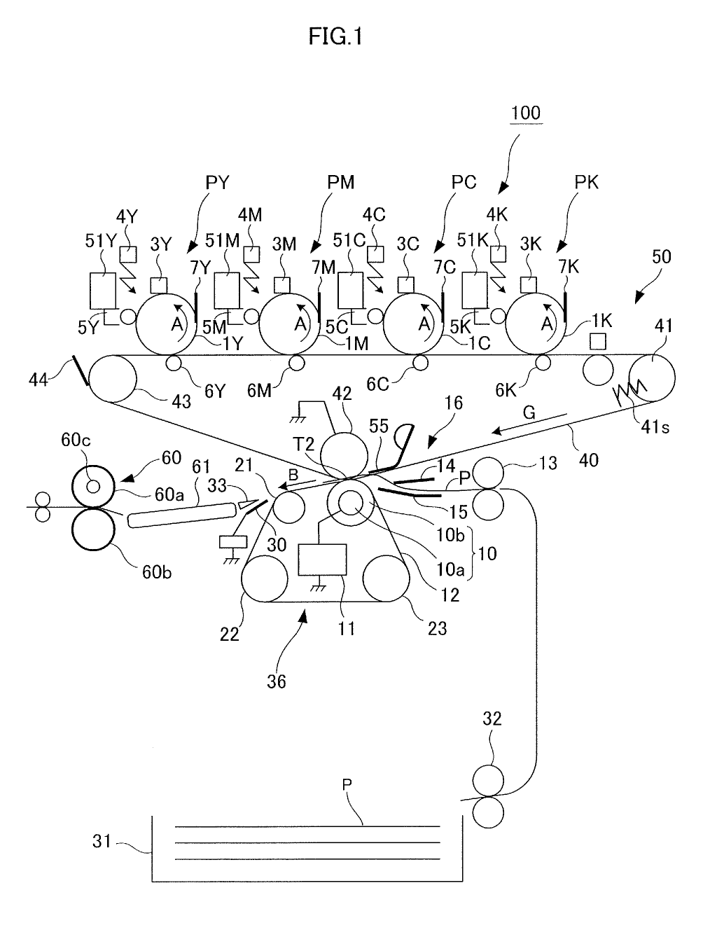

FIG. 1 is an explanatory view illustrating a configuration of an image forming apparatus. As shown in FIG. 1, an image forming apparatus 100 is a tandem intermediate transfer type full-color printer in which image forming portions PY, PM, PC and PK of process cartridges are arranged along an upper surface of an intermediate transfer belt 40. In the present embodiment, the image forming apparatus 100 is provided, for example, with image forming portions PY, PM, PC and PK, an intermediate transfer unit 50, a secondary transfer belt unit 36, a fixing unit 60, a recording medium cassette 31, and so on.

In the image forming portion PY, a yellow toner image is formed on a photosensitive drum 1Y, which is then transferred to the intermediate transfer belt 40. In the image forming portion PM, a magenta toner image is formed on a photosensitive drum 1M, which is then transferred to the intermediate transfer belt 40. In the image forming portions PC and PK, cyan and black toner images are formed respectively on photosensitive drums 1C and 1K, which are transferred to the intermediate transfer belt 40.

The four color toner images transferred to the intermediate transfer belt 40 are conveyed to a secondary transfer portion T2, where they are secondarily transferred to a recording medium P. The recording medium P is taken out from the recording medium cassette 31, separated by a separating roller 32 to single sheets, and sent into a registration roller 13. The registration roller 13 delivers the recording medium P to the secondary transfer portion T2 while synchronizing with the toner image on the intermediate transfer belt 40.

The secondary transfer belt unit 36 is in contact with the intermediate transfer belt 40 having its inner side surface supported by a secondary transfer inner roller 42, and forms the secondary transfer portion T2. By having voltage applied to a secondary transfer roller 10, the toner image on the intermediate transfer belt 40 is secondarily transferred to the recording medium P being conveyed in the secondary transfer portion T2.

The recording medium P to which the four color toner images are secondarily transferred is conveyed by a conveying belt 61 and sent into the fixing unit 60, where heat and pressure are applied and the images are fixed to the surface of the recording medium. The fixing unit 60 applies predetermined amounts of pressure and heat via a nip formed of a fixing roller 60a equipped with a heater 60c and a pressure roller 60b, and fixes the toner images on the recording medium P by melting.

### (Image Forming Portion)

The image forming portions PY, PM, PC and PK are configured substantially in the same manner, except that the colors of toners in developing apparatuses 5Y, 5M, 5C and 5K differ, which are yellow, magenta, cyan and black. Therefore, in the following description, the image forming portion PY will be described, and the same explanation for other image forming portions PM, PC and PK will be omitted.

In the image forming portion PY, a charging unit 3Y, an exposure apparatus 4Y, a developing apparatus 5Y, a primary transfer roller 6Y and a drum cleaning device 7Y are disposed around the photosensitive drum 1Y. The photosensitive drum 1Y is provided with a photosensitive layer formed around an outer circumferential surface of an aluminum cylinder, and is rotated in a direction of arrow A at a predetermined process speed.

The charging unit 3Y electrifies the photosensitive drum 1Y with homogeneous negative part potential. The exposure apparatus 4Y draws an electrostatic latent image of an image on the surface of the photosensitive drum 1Y by scanning, using a rotational mirror, a laser beam generated from an image signal having developed image data into a scan line.

The developing apparatus 5Y transfers a negatively charged toner to the electrostatic latent image on the photosensitive drum 1Y, and develops the electrostatic latent image to a toner image. In the first embodiment, each toner image of the respective colors transferred to the recording medium P has a maximum reflection density of approximately 1.5 to 1.7. An applied amount of toner of the toner image in the maximum reflection density is approximately 0.4 to 0.6 mg/cm². A developer supplying portion 51Y feeds the equivalent amount of toner extracted from the developing apparatus 5Y when forming an image to the developing apparatus 5Y.

The primary transfer roller 6Y presses the intermediate transfer belt 40, and forms a primary transfer portion between the photosensitive drum 1Y and the intermediate transfer belt 40. By applying DC voltage having a positive polarity to the primary transfer roller 6Y, the toner image having a negative polarity carried on the photosensitive drum 1Y is transferred to the intermediate transfer belt 40.

The drum cleaning device 7Y recovers transfer residual toner remaining on the surface of the photosensitive drum 1Y by bringing a cleaning blade in contact with the surface of the photosensitive drum 1Y.

### (Intermediate Transfer Unit)

The intermediate transfer unit 50 is equipped with an intermediate transfer belt 40, a guide portion 16, a backup sheet 55 and so on.

### (Intermediate Transfer Belt)

The intermediate transfer belt 40 is stretched by a driving roller 43, a tension roller 41 and a secondary transfer inner roller 42, which is driven by the driving roller 43 and rotated in a direction of arrow G at a rotating speed of 250 to 300 [mm/sec].

The intermediate transfer belt 40 is formed by arranging an elastic layer formed of a rubber material having a thickness of 120 to 180 μm on a surface of a base layer formed of a resin material such as polyimide or polycarbonate having a thickness of 70 μm, and further arranging a surface layer having a thickness of 5 to 10 μm on the surface of the elastic layer, so that the total thickness thereof is 200 to 250 μm. The rubber material can be an urethane rubber, a chloroprene rubber and the like. The surface layer makes the toner adhesion power to the surface of the intermediate transfer belt 40 small, and enables toner to be readily transferred to the recording medium P at the secondary transfer portion T2. Volume resistivity of the intermediate transfer belt 40 is modified to 1×10⁹ to 1×10¹⁴ [Q·cm] by adding carbon black as an antistatic agent to the respective layers.

The surface layer can be formed of one resin material among polyurethane, polyester, epoxy resin, fluororesin and the like. It is also possible to use a mixture of two or more types of elastic materials among elastic rubber, elastomer, butyl rubber and the like, in which one or two or more types of powdered particles of fluoro-resin and the like or powdered particles having different particle sizes are dispersed and blended to reduce the surface energy and enhance lubrication.

The tension roller 41 is provided with force by pressure springs 41s arranged at both ends of a rotation axis to be protruded toward the intermediate transfer belt 40, and applies a substantially constant tension of approximately 20 to 50 N (approximately 2 to 5 kgf) to the intermediate transfer belt 40 in the conveyance direction. A belt cleaning unit 44 brings a cleaning blade into sliding contact with the surface of the intermediate transfer belt 40, and recovers the transfer residual toner remaining on the surface of the intermediate transfer belt 40.

### (Guide Portion)

The guide portion 16 is equipped with a lower guide 15 as an example of a first guide member, and an upper guide 14 as an example of a second guide member. The upper and lower guides 14 and 15 form a conveying path of the recording medium P where the recording medium P is conveyed from the registration roller 13 to the secondary transfer portion T2. The lower guide 15 is arranged at the outer circumference side of the intermediate transfer belt 40, and restricts the movement of the recording medium P from moving away from the surface of the intermediate transfer belt 40. The upper guide 14 is arranged between the intermediate transfer belt 40 and the lower guide 15, and restricts the movement of the recording medium P from moving toward the surface of the intermediate transfer belt 40.

The upper and lower guides 14 and 15 are disposed upstream from the secondary transfer portion T2 in the conveyance direction of the recording medium P, guiding the recording medium P to the secondary transfer portion T2 and overlaying the recording medium P at a predetermined position on the surface of the intermediate transfer belt 40.

As described, the image forming portion PY as an example of the toner image forming portion forms the toner image and has the image carried on the intermediate transfer belt 40.

The pressure spring 41s as an example of a biasing member biasing both ends of the tension roller 41 as an example of a tension applying portion and tension roller toward the intermediate transfer belt 40, to thereby apply tension to the intermediate transfer belt 40.

The secondary transfer inner roller 42 as an example of a support roller is in contact with an inner side surface of the intermediate transfer belt 40 and forms a curved surface of the intermediate transfer belt 40.

A secondary transfer belt 12 as an example of a rotator nips the intermediate transfer belt 40 with the secondary transfer inner roller 42, and forms a secondary transfer portion T2 as an example of a nip portion.

A secondary transfer power supply 11 as an example of a power supply applies voltage between the secondary transfer belt and the secondary transfer inner roller 42 to transfer the toner image onto the recording medium P being conveyed through the secondary transfer portion T2.

The upper guide 14 guides the recording medium P fed to the secondary transfer portion T2 so that the recording medium P is overlaid with the intermediate transfer belt 40 upstream from the secondary transfer portion T2 in the direction of rotation of the intermediate transfer belt 40. The upper guide 14 is arranged to release the restriction of a rear end of the recording medium P at a position separated from the intermediate transfer belt 40 closer to the secondary transfer portion T2 than the position in which the backup sheet 55 is in contact with the intermediate transfer belt 40.

### (Secondary Transfer Belt Unit)

As shown in FIG. 1, the secondary transfer belt unit 36 causes the recording medium P to be carried on the secondary transfer belt 12 and passed through the secondary transfer portion T2. By using the secondary transfer belt 12, it becomes possible to easily separate the recording medium P from the intermediate transfer belt 40 after transferring the toner image thereto at the secondary transfer portion T2, and to stably convey the recording medium P to the fixing unit 60.

The secondary transfer belt unit 36 is configured by stretching the secondary transfer belt 12 in a rotatable manner around the secondary transfer roller 10, a conveying surface forming roller 21, a tension roller 22 and a drive roller 23. The secondary transfer belt 12 is driven by the drive roller 23 and rotated in the direction of arrow B.

The secondary transfer belt 12 is formed of a resin material whose volume resistivity is modified to 1×10⁹ to 1×10¹⁴ [Q·cm] by adding an appropriate amount of carbon black as an antistatic agent to a resin material such as polyimide or polycarbonate. The secondary transfer belt 12 has a single layer structure with a thickness of 0.07 to 0.1 mm. The secondary transfer belt 12 has a Young's module value of 100 MPa or greater and 10 GPa or smaller measured via tensile testing (JIS K 6301).

The secondary transfer roller 10 is formed by arranging an elastic layer 10b of ion conductive foamed rubber (NBR rubber) on an outer circumference of a stainless steel round bar core metal 10a, and has an outer diameter of 24 mm. The elastic layer 10b of the secondary transfer roller 10 has a surface roughness Rz of 6.0 to 12.0 [μm]. A resistance value measured by applying 2 kV under a normal temperature and normal humidity environment (N/N: 23° C., 50% RH) is 1×10⁵ to 1×10⁷ [Ω]. An Asker C hardness of the elastic layer 10b is around 30 to 40.

The secondary transfer inner roller 42 supports the inner side surface of the intermediate transfer belt 40 passing through the secondary transfer portion T2. The secondary transfer roller 10 presses the secondary transfer belt 12 and forms a secondary transfer portion T2 of the toner image between the intermediate transfer belt 40 supported by the secondary transfer inner roller 42 and the secondary transfer belt 12. The secondary transfer power supply 11 having a variable output current is connected to the secondary transfer roller 10. The secondary transfer power supply 11 automatically controls the output voltage so that a transfer current of +40 to 60 μA is supplied, as an example. The secondary transfer power supply 11 applies transfer voltage to the secondary transfer roller 10, and causes the toner image carried on the intermediate transfer belt 40 to be secondarily transferred to the recording medium P on the secondary transfer belt 12. The recording medium P is adsorbed to the secondary transfer belt 12 by static electricity applied from the secondary transfer power supply 11 along with the secondary transfer of the toner image.

The conveying surface forming roller 21 arranged downstream from the secondary transfer roller 10 also functions as a separating roller. After reaching the conveying surface forming roller 21, the recording medium P on the secondary transfer belt 12 is separated from the secondary transfer belt by a curvature of the curved surface of the secondary transfer belt 12 along the circumferential surface of the conveying surface forming roller 21. The recording medium P having been separated by curvature from the secondary transfer belt 12 is conveyed to the conveying belt 61, and sent to the fixing unit 60. A separation claw 33 prevents the recording medium P separated from the secondary transfer belt 12 from being statically attracted again to the secondary transfer belt 12.

The tension roller 22 arranged downstream from the conveying surface forming roller 21 has force provided to both ends thereof by pressure springs toward the direction to protrude toward the secondary transfer belt 12, and applies a predetermined tension to the secondary transfer belt 12.

As described above, the secondary transfer belt 12 which is an example of a transfer belt carries and conveys the recording medium P. The secondary transfer roller 10 as an example of a transfer roller nips the intermediate transfer belt and the secondary transfer belt 12 with the secondary transfer inner roller 42. The conveying surface forming roller 21 as an example of a transfer belt stretch roller supports the secondary transfer belt 12 in a stretched manner downstream from the secondary transfer roller 10 in the direction of rotation of the secondary transfer belt 12.

### (Void Phenomenon)

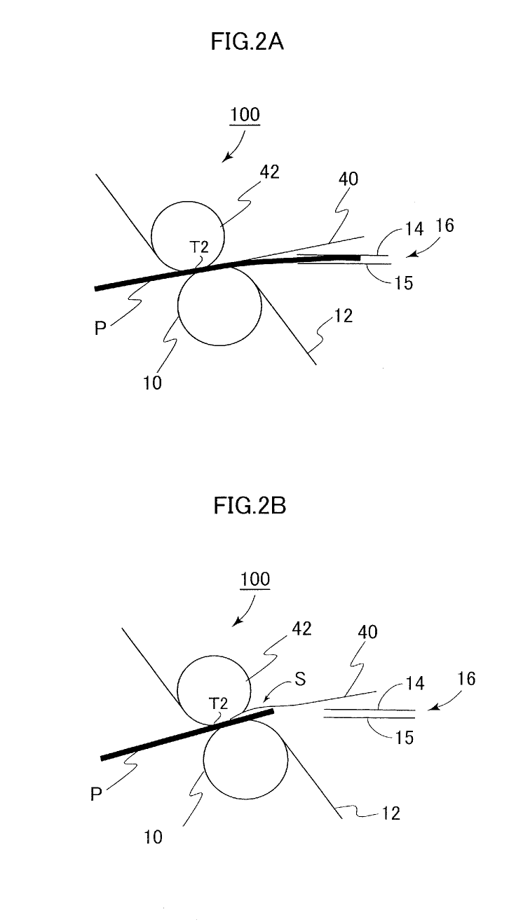

FIGS. 2A and 2B are explanatory views illustrating a guided state of the recording medium P by the guide portion 16. As shown in FIG. 1, if the electric field of the secondary transfer portion T2 is too intense, reverse polarity charges enter the toner through discharge, and the electric charge approximates zero. Toner having electric charge approximating zero will not be transferred to the recording medium P, and a void occurs to the image at the discharge position. This is called a void phenomenon. Void phenomenon occurs with higher frequency as the intensity of the electric field applied on the secondary transfer portion T2 increases, which is called a void phenomenon.

There are different levels in void phenomenon, depending on the status of load received by the toner. An external additive mixed into the toner also functions to reduce the adhesion power of toner with other objects. Therefore, if load applied on the toner is accumulated by the stirring of the developer and external additives fall off from the toner, the adhesive power of the toner with the intermediate transfer belt 40 is increased, and the void phenomenon is actualized further. Therefore, a control method has been proposed to prevent load from being accumulated in the toner by discharging the developer inside the developing apparatus 5Y to the photosensitive drum 1Y during the time where image is not formed on the recording medium P. By discharging the toner having been stirred for a long time in the developing apparatus 5Y and supplying a new toner, the status of the toner can be maintained to a good state and the occurrence of the void phenomenon can be suppressed. However, the discharging of the toner in the developing apparatus 5Y causes unnecessary increase of the amount of toner consumption, so that this method causes undesirable increase of the running costs of the image forming apparatus 100.

Further, the void phenomenon occurs when the electric field of the secondary transfer portion T2 is intense. Therefore, a proposal has been made to reduce the absolute value of the transfer voltage applied on the secondary transfer roller 10 when transferring the toner image to the recording medium P. However, when the absolute value of the transfer voltage is reduced, the transfer current will become insufficient and the image area having a high density cannot be secondarily transferred sufficiently, and there is high probability that the image quality of the high density image formed on the recording medium P is deteriorated.

Incidentally, vibration of the intermediate transfer belt 40 near the secondary transfer portion T2 influences the quality of the output image greatly. As shown in FIG. 2B, discharge that causes the void phenomenon may occur easily if there is a space S formed between the surface of the intermediate transfer belt 40 carrying the toner image and the surface of the recording medium P. When the intermediate transfer belt 40 vibrates close to the secondary transfer portion T2, minute spaces S are easily formed between the toner image carrying surface of the intermediate transfer belt 40 and the surface of the recording medium P, by which the void phenomenon becomes prominent. Therefore, by increasing a spring coefficient of the pressure springs 41s arranged at both ends of the tension roller 41 to increase the tension of the intermediate transfer belt 40, the vibration of the intermediate transfer belt 40 can be reduced, and the occurrence of the void phenomenon can be suppressed.

Furthermore, by having a belt guide member be in contact with a rear surface of the intermediate transfer belt 40 in the vicinity of the secondary transfer portion T2, the vibration of the intermediate transfer belt 40 near the secondary transfer portion T2 can be suppressed. Therefore, by providing a belt guide member in the vicinity of the secondary transfer portion T2 and changing the direction of rotation of the intermediate transfer belt 40, the vibration of the intermediate transfer belt 40 in the vicinity of the secondary transfer portion T2 can be reduced. As a result, void phenomenon will not occur easily to the toner image on the recording medium P being conveyed in the secondary transfer portion T2, and traces of discharge observed on the output image is reduced, according to which the quality of the output image is improved.

However, it has been found that if the stiffness of the belt guide member is too high, spattering tends to occur to the toner image on the recording medium P being nipped and conveyed in the secondary transfer portion T2 when a recording medium P having a high thickness or a recording medium P having a high stiffness is used to form images.

As shown in FIG. 2A, while the recording medium P is guided by the upper guide 14, shock will not occur to the intermediate transfer belt 40 even if the stiffness of the belt guide member is high. However, if the stiffness of the belt guide member is too high, shock occurs at a timing when the rear end of the recording medium P passes through the upper guide 14 and comes into contact with the intermediate transfer belt 40, as shown in FIG. 2B, possibly causing spattering of the toner image carried on the intermediate transfer belt 40.

Therefore, according to the first embodiment, elasticity, that is, spring force, is provided to the backup sheet 55 supporting the inner side surface of the intermediate transfer belt 40, so as to relieve the shock caused when the rear end of the recording medium P passes through the upper guide 14 and comes into contact with the intermediate transfer belt 40.

### (Backup Sheet)

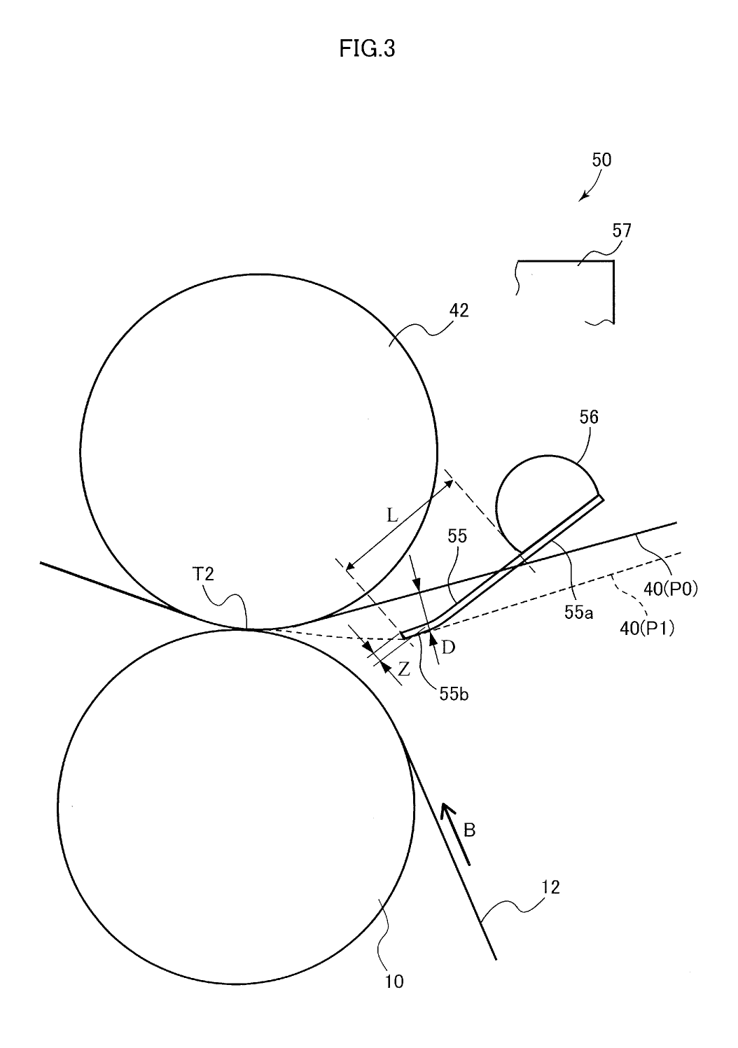

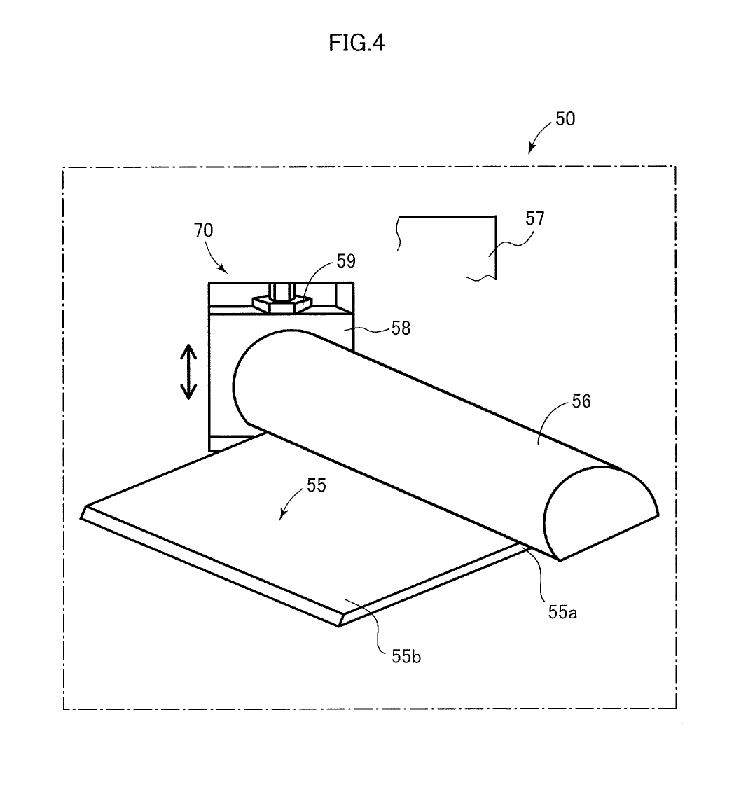

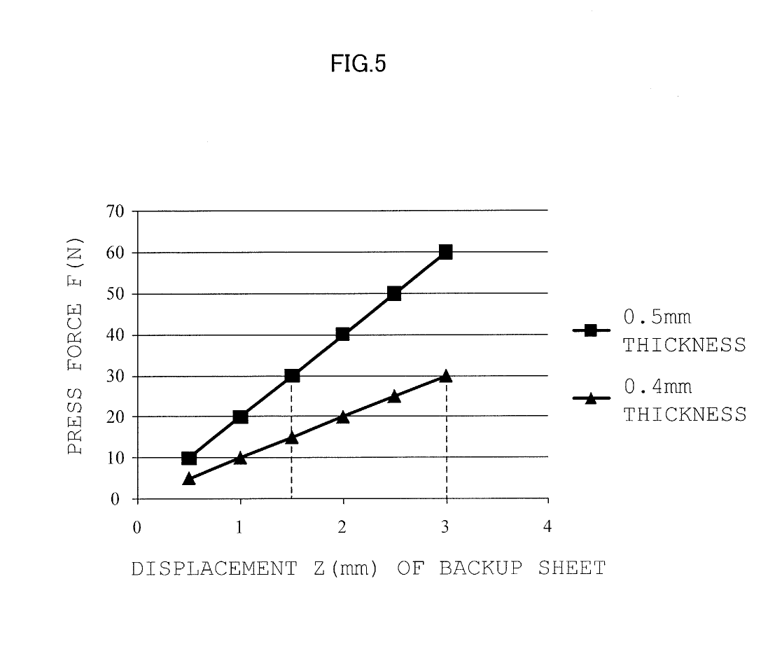

FIG. 3 is an explanatory view showing an arrangement of the backup sheet. FIG. 4 is a perspective view of the state of attachment of the backup sheet 55. FIG. 5 is an explanatory view of the relationship of thickness, the amount of displacement (deflection) and the press force of the backup sheet 55.

As shown in FIG. 3, in the first embodiment, this backup sheet 55 is provided as a press member for preventing vibration of the intermediate transfer belt 40 upstream from the secondary transfer inner roller 42. The backup sheet 55 is arranged on the rear surface of the intermediate transfer belt upstream from the secondary transfer portion T2, which is elastically bent and having one end of a tip side thereof in contact with the intermediate transfer belt 40.

Here, as shown in FIG. 4, the intermediate transfer unit 50 of the image forming apparatus 100 is equipped with side panels 57 as an example of a pair of frame members, a the support member 56 as an example of a cantilever support member, and an adjustment mechanism 70. The side panels 57 are arranged in a width direction perpendicular to the direction of rotation of the intermediate transfer belt 40 with the intermediate transfer belt 40 interposed therebetween, for supporting the tension roller 41 and the secondary transfer inner roller 42. The support member 56 is arranged in parallel with the secondary transfer inner roller 42 and upstream in the direction of rotation of the intermediate transfer belt 40 from the position in which the backup sheet 55 is in contact with the intermediate transfer belt 40, being supported by the side panels 57 and supporting the backup sheet 55 in a cantilever. The backup sheet 55 is stuck to the support member 56 using a double sided tape.

The adjustment mechanism 70 is capable of adjusting and fixing the position in which the support member 56 is supported on the side panels 57, and by adjusting the support position, the press force in which the backup sheet 55 elastically presses the inner side surface of the intermediate transfer belt 40 can be adjusted. The adjustment mechanism 70 is provided with an elevating block 58 capable of moving up and down with respect to the side panels 57, and an adjusting nut 59. Both ends of the support member 56 are fixed to a non-rotating elevating block 58, and fixed in a manner capable of having its height position adjusted with respect to the side panels 57. The support member 56 can be fixed to the side panels 57 by loosening the adjusting nut 59 enabling adjustment in the vertical direction, moving the elevating block 58, and tightening the nut 59 again.

The backup sheet 55 is an elastic plate member having a fixed end portion 55a disposed upstream in the direction of rotation of the intermediate transfer belt 40, and a free end portion 55b disposed downstream in the direction of rotation of the intermediate transfer belt 40 and in contact with the inner side surface of the intermediate transfer belt 40 to elastically press the intermediate transfer belt 40, wherein the fixed end portion 55a is supported in a cantilever by the support member 56.

The backup sheet 55 is an elastic plate member formed of a resin material such as polyester with a thickness of approximately 0.4 to 0.6 mm. The length of the backup sheet 55 along the secondary transfer inner roller 42 is 330 to 380 mm. The backup sheet 55 is pressed against the intermediate transfer belt 40 by the force in which the elastic plate supported in a cantilever is bent, and as the press force increases, the effect of preventing the vibration of the intermediate transfer belt 40 and suppressing the void phenomenon can be enhanced.

The backup sheet 55 is arranged so that the tip of the free end portion 55b thereof does not contact the secondary transfer inner roller 42 even when it is bent. The tip of the backup sheet 55 is in contact with the rear surface (inner side surface) of the intermediate transfer belt 40 at a position separated by 3 to 15 mm upstream in the direction of rotation from the position in which the secondary transfer inner roller and the intermediate transfer belt 40 contact each other. Specifically, the tip of the free end portion 55b of the backup sheet 55 is in contact with the rear surface of the intermediate transfer belt 40 at a position separated by 7 to 8 mm (deflection being a tolerance) upstream in the direction of rotation from the position in which the secondary transfer inner roller 42 and the intermediate transfer belt 40 contact each other.

As shown in FIG. 3, the tip of the free end portion 55b of the backup sheet 55 is made to be in contact with a tension surface of the intermediate transfer belt 40. The cantilever length of the backup sheet 55 and the height of the elevating block 58 are adjusted to so that the tension surface is protruded outward for distance D from the state where the backup sheet 55 is not provided. At this time, the tip of the free end portion 55b of the backup sheet 55 is displaced by distance Z through bending, compared to a state where the backup sheet 55 is not in contact with the secondary transfer inner roller 42 and no load is applied thereto.

The backup sheet 55 pushes the tip side of the free end portion 55b onto the intermediate transfer belt 40, so that the tension surface of the intermediate transfer belt 40 upstream from the secondary transfer portion T2 is pushed downward. Thereby, the effect of preventing the vibration of the intermediate transfer belt 40 is enhanced. However, the intermediate transfer belt 40 is stretched with tension. The tension of the intermediate transfer belt 40 is a tension calculated so that the total pressure applied on both ends of the tension roller 41 by the pressure spring 41s is distributed in the direction of tension of the intermediate transfer belt 40, which is 20 to 50 N (approximately 2 to 5 kgf) as described earlier. Therefore, the force in which the backup sheet 55 pushes the intermediate transfer belt 40 must be set sufficiently high to satisfactorily displace the tension surface of the intermediate transfer belt 40 downward, or else the effect of preventing vibration of the intermediate transfer belt 40 may be insufficient.

Now, the quality of the formed image and the rotation status of the intermediate transfer belt 40 of various cases have been tested, by changing the relative relationship of the press force of the backup sheet 55 to the tension of the intermediate transfer belt 40. The results are shown in Table 1.

### Example 1

The tension of the intermediate transfer belt 40 was set to 30 N, and the press force of the backup sheet 55 was set to 30N. As a result, no image defection was caused, and the intermediate transfer belt 40 could rotate.

### Example 2

The tension of the intermediate transfer belt 40 was set to 30 N, and the press force of the backup sheet 55 was set to 40 N. As a result, no image defection was caused, and the intermediate transfer belt 40 could rotate.

### Comparative Example 1

The tension of the intermediate transfer belt 40 was set to 30 N, and the press force of the backup sheet 55 was set to 20 N. As a result, image defection was caused, and the intermediate transfer belt 40 could rotate.

### Comparative Example 2

The tension of the intermediate transfer belt 40 was set to 30 N, and the press force of the backup sheet 55 was set to 25 N. As a result, image defection was caused, and the intermediate transfer belt 40 could rotate.

### Comparative Example 3

The tension of the intermediate transfer belt 40 was set to 30 N, and the press force of the backup sheet 55 was set to 50 N. As a result, no image defection was caused, but the intermediate transfer belt 40 could not rotate.

TABLE 1

| | INTER- | | | |
|---|---|---|---|---|
| | MEDIATE | BACKUP | | |
| | TRANSFER | SHEET | IMAGE | |
| | BELT | PRESS | DEFEC- | OPER- |
| | TENSION | FORCE | TION | ATION |
| EXAMPLE 1 | 30 N | 30 N | NONE | POSSIBLE |
| EXAMPLE 2 | 30 N | 40 N | NONE | POSSIBLE |
| COMPARATIVE | 30 N | 20 N | PRESENT | POSSIBLE |
| EXAMPLE 1 | | | | |
| COMPARATIVE | 30 N | 25 N | PRESENT | POSSIBLE |
| EXAMPLE 2 | | | | |
| COMPARATIVE | 30 N | 50 N | NONE | NOT |
| EXAMPLE 3 | | | | POSSIBLE |

As shown in Table 1, according to the first embodiment, the force in which the backup sheet 55 presses the intermediate transfer belt 40 is set to a force equal to or greater than the tension applied on the intermediate transfer belt 40 (refer to examples 1 and 2), by which the intermediate transfer belt 40 is suppressed from being vibrated in the vicinity of the secondary transfer portion T2. Specifically, the force in which the backup sheet 55 presses the rear surface of the intermediate transfer belt 40 is equal to or greater than the tension that the tension roller 41 applies to the intermediate transfer belt 40. Therefore, the backup sheet 55 can overcome the tension of the intermediate transfer belt 40 and change the tension surface of the intermediate transfer belt 40 sufficiently at the upstream area of the secondary transfer portion T2, thereby suppressing the vibration of the intermediate transfer belt 40.

By the backup sheet 55 suppressing the vibration of the intermediate transfer belt 40, discharge gap will not easily occur between the intermediate transfer belt 40 and the recording medium P at the secondary transfer portion T2, and the occurrence of the void phenomenon of the toner image caused by discharge can be suppressed. The occurrence of image defection caused by the discharge on the upstream side of the secondary transfer portion T2 can be reduced.

From the viewpoint of whether the tension surface of the intermediate transfer belt 40 is changed or not, the tension surface of the intermediate transfer belt 40 will change even if the force in which the backup sheet 55 presses the intermediate transfer belt 40 is equal to or smaller than the tension of the intermediate transfer belt 40 (refer to Comparative Examples 1 and 2). However, in order to sufficiently prevent the void phenomenon being the issue here, it is preferable to press the intermediate transfer belt 40 with greater force, and as a result of repeated experiments and studies, it has been concluded that the void phenomenon can be prevented sufficiently if the force is equal to or greater than the tension of the intermediate transfer belt 40.

However, if the press force is too high, image defection, so-called “density unevenness”, where the strong friction of the toner image on the intermediate transfer belt 40 and the recording medium P upstream from the secondary transfer portion T2 causes the toner image to be mechanically disarrayed, tends to occur. In other cases, the tension surface of the backup sheet 55 may be lowered excessively, in contact with the upper guide 14 shown in FIG. 1 and disturbing the rotation of the intermediate transfer belt 40 (refer to Comparative Example 3). The image defection of “density unevenness” may also be influenced by the rush-in angle and the like of the recording medium P with respect to the intermediate transfer belt 40 upstream from the secondary transfer portion T2 illustrated in FIGS. 2A and 2B, so that it cannot be defined only by the press force of the backup sheet 55.

The backup sheet 55 has its fixed end portion 55a supported in a cantilever by the support member 56, so that the tip side of the free end portion 55b can bend freely. The backup sheet 55 pushes down the tension surface of the intermediate transfer belt 40. Here, the length of the backup sheet 55 along the longitudinal direction of the secondary transfer inner roller 42 is denoted as b. The length of the beam portion of the backup sheet 55 is denoted as free length L, the thickness is denoted as thickness h, and the Young's module is denoted as E. The length in which the tip portion of the free end portion 55b of the backup sheet 55 is displaced by pressing the intermediate transfer belt 40 compared to when no load is applied thereto is referred to as an amount of displacement (deflection of the backup sheet 55) Z. Incidentally, the amount of displacement Z of the backup sheet 55 is a length that differs from the amount of projection D of the intermediate transfer belt 40, so that the two lengths may not correspond. Therefore, if the thickness h or the free length L of the backup sheet 55 differ, the amount of displacement Z of the backup sheet 55 may differ even if the amount of projection D of the intermediate transfer belt 40 is made constant.

At this time, the press force F caused by the bending of the backup sheet 55 can be calculated by the following expression, based on a bend expression of the cantilever beam.

F=3×Z×E×I/L³ Expression (1)

I denotes a cross-sectional secondary moment of the backup sheet 55 having a uniform thickness in the longitudinal direction.

I=b×h³/12

Therefore, Expression (1) can be represented by the following expression format.

F=Z×E×b×h³/(4×L³) Expression (2)

The relationship between thickness h and amount of displacement Z of the backup sheet 55 obtained by the above-described Expression (2) is illustrated in FIG. 5. Then, as shown in Table 1, image forming using a thick recording medium P was performed under a typical condition to confirm whether image deflection is caused by the void phenomenon. The thickness h of the backup sheet 55 was varied between 0.4 mm and 0.5 mm, and whether image deflection by the void phenomenon has occurred or not was confirmed. As a result, it has been confirmed that if the press force F calculated by the above-described Expression (2) is greater than 30 N (approximately 3 kgf) which is the tension of the intermediate transfer belt 40, vibration of the intermediate transfer belt 40 could be suppressed sufficiently and the void phenomenon could be satisfactorily prevented (Examples 1 and 2).

Incidentally, in the calculation of Expression (2), the respective parameters were set as follows. The polyethylene film used as the backup sheet 55 had a Young's module E of 4000 MPa. The length b of the backup sheet 55 was 370 mm, and the free length L was 13.5 mm. The distance between the secondary transfer portion T2 and the tip of the backup sheet 55 was 7 to 8 mm, and the contact length of the tip of the backup sheet 55 and the intermediate transfer belt 40 in the rotating direction was 1 to 2 mm.

Moreover, the amount of displacement Z of the backup sheet 55 was obtained by measuring the change of tip position of the backup sheet 55 between a case where the intermediate transfer belt 40 was attached to the intermediate transfer unit 50 and a case where the belt 40 was removed therefrom.

The tension on the intermediate transfer belt 40 is applied from the pressure springs 41s disposed at both ends of the tension roller 41, so that it can be calculated based on the force provided from the pressure spring 41s and the angle of the intermediate transfer belt 40 wound around the tension roller 41. Here, the tension of the intermediate transfer belt 40 was 30 N (approximately 3 kgf).

When the press force F was equal to or greater than 30 N (approximately 3 kgf) which is the tension of the intermediate transfer belt 40, void phenomenon was sufficiently suppressed, and there was no visible image deflection caused by void phenomenon on the output image.

Incidentally, as shown in FIG. 5, if the thickness h of the backup sheet 55 is 0.5 mm, the amount of displacement Z necessary for the press force F to be equal to or greater than N (approximately 3 kgf) is 1.5 mm, from Expression (2). However, if the thickness h of the backup sheet 55 is 0.4 mm, the force required for realizing the amount of displacement Z is approximately half compared to when the thickness is 0.5 mm from Expression (2), so that the required amount of displacement Z is 3 mm.

As prescribed in Expression (2), the press force F by which the backup sheet 55 presses the intermediate transfer belt is proportional to the third power of thickness h of the backup sheet 55. Therefore, in order to displace the intermediate transfer belt 40 for the same amount of projection D, if the thickness of the backup sheet 55 is ½, the amount of displacement Z of the backup sheet 55 must be eight times greater.

In the first embodiment, the backup sheet 55 as an example of the press member presses the inner side surface of the intermediate transfer belt 40 upstream from the secondary transfer portion T2 in the direction of rotation of the intermediate transfer belt 40. The press force of the backup sheet 55 with respect to the inner side surface of the intermediate transfer belt 40 is greater than 30 N, which is one example of the tension that occurs to the intermediate transfer belt 40 by the pressure spring 41s at a position adjacent to the tension roller 41. Therefore, the vibration of the intermediate transfer belt 40 on the upstream side of the secondary transfer portion T2 can be restricted, and image defection caused by transfer failure can be reduced.

That is, according to the first embodiment, both the amplitude and shock caused by the vibration of the intermediate transfer belt 40 when the rear end of the recording medium P having passed through the guide portion 16 in contact with the intermediate transfer belt 40 are reduced by the backup sheet 55. Thus, even if the recording medium P is thick and the stiffness of the recording medium P is high, image defection caused by discharge that may occur at the rear end portion of the recording medium P can be reduced.

In the first embodiment, the backup sheet 55 is an elastic plate member arranged along the secondary transfer inner roller 42 as an example of a support roller with its tip side positioned toward the secondary transfer portion T2, and bent in a cantilever-like state by having one side of the tip be in surface contact with the inner side surface of the intermediate transfer belt 40. Thus, the curved surface of the backup sheet can guide the intermediate transfer belt 40 smoothly. Moreover, when the rear end of the recording medium P collides against the intermediate transfer belt 40, the impact of collision of the recording medium P can be absorbed by the elasticity of the backup sheet 55, preventing the toner image from being scattered by the impact.

As shown in FIG. 4, in the first embodiment, the side panels 57 which are an example of the pair of frame members are arranged in a width direction perpendicular to the direction of rotation of the intermediate transfer belt 40 with the intermediate transfer belt 40 interposed therebetween, and supports both ends of the tension roller (41: FIG. 1) and the secondary transfer inner roller (42: FIG. 1) in a rotatable manner. As shown in FIG. 3, the support member 56 is arranged in parallel with the secondary transfer inner roller 42 upstream in the direction of rotation of the intermediate transfer belt 40 to the position where the backup sheet 55 is in contact with the intermediate transfer belt 40. The support member 56 has both ends thereof supported by the pair of side panels 57 and supports the backup sheet 55 in a cantilever. Therefore, it can be arranged in a compact manner in the limited space within the intermediate transfer unit 50, and the costs of components are inexpensive.

According to the first embodiment, the backup sheet 55 functioning as the press member can change the tension surface of the intermediate transfer belt 40 upstream from the secondary transfer portion T2 without yielding to the tension of the intermediate transfer belt 40, and prevent vibration of the intermediate transfer belt 40. Since the vibration of the intermediate transfer belt 40 that causes a discharge gap with the recording medium P at the secondary transfer portion T2 can be suppressed, the occurrence of void phenomenon which leads to image defection can be suppressed.

### Second Embodiment

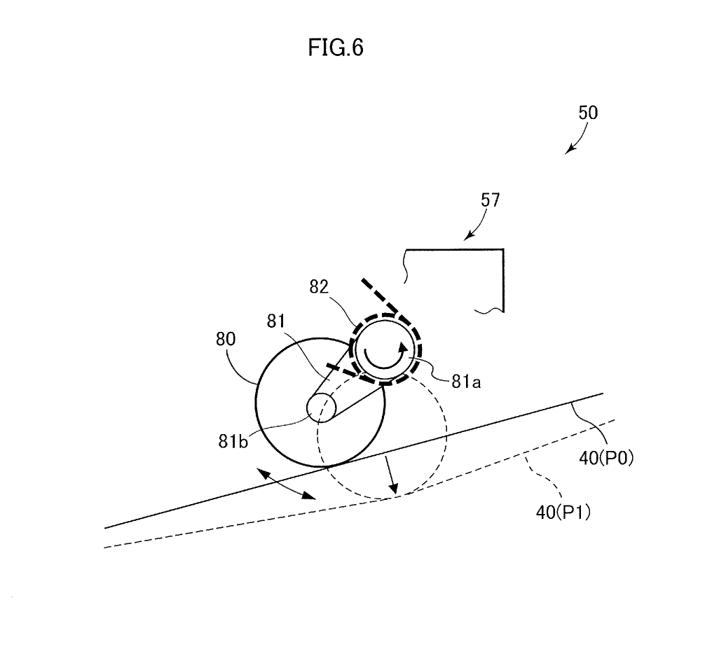

Next, a second embodiment of the image forming apparatus 100 will be described. FIG. 6 is an explanatory view illustrating an arrangement of a backup roller 80 according to a second embodiment. In the first embodiment, a sheet-like backup sheet 55 has been adopted as the press member. In contrast, according to the second embodiment, a roller-like backup roller as an example of a press roller is adopted as the press member. The other configurations of the second embodiment are similar to the first embodiment, so they are denoted with the same reference numbers and will not be described in detail.

As shown in FIG. 6, the intermediate transfer unit 50 of the image forming apparatus 100 is equipped with side panels 57 which are an example of the pair of frame members, an arm member 81, and a torsion coil spring 82 as an example of a spring member. The arm member 81 includes a center-side end section 81a supported rotatably by the side panels 57, and a revolving-side end section 81b supporting the backup roller 80 rotatably. That is, both ends of the center-side end section 81a in the rotational axis direction of the backup roller 80 are fixed to the side panels 57. The backup roller 80 is attached rotatably to the revolving-side end section 81b of the arm member 81 which is capable of revolving around the center-side end section 81a.

The torsion coil spring 82 biases the arm member 81 so that the backup roller 80 is in contact with the inner side surface of the intermediate transfer belt 40 and elastically presses the intermediate transfer belt 40. In other words, the torsion coil spring 82 biases the arm member 81 in such a direction that the backup roller 80 is pressed against the intermediate transfer belt 40. By having the arm member 81 revolve around the center-side end section 81a, the backup roller 80 presses the intermediate transfer belt 40 and pushes down the tension surface.

### Modified Example

The present invention can also be implemented in a different example where a portion or all of the configurations of the first or second embodiments is/are replaced with alternative configuration(s). According to the first embodiment, only the major sections related to the forming and transferring of toner images have been described, but the present invention can be implemented for various purposes, such as in printers, printing presses, copying machines, facsimiles, multifunctional machines and so on by adding the necessary devices, equipment, housing structures and so on.

In the first embodiment, the backup sheet 55 and the support member 56 are fixed using a double-sided tape. However, other methods can be adopted, such as forming screw holes on the support member 56 and engaging the support member 56 and the backup sheet 55 using screws. The support member 56 can also be secured directly to the side panels 57 of the intermediate transfer unit 50.

In the second embodiment, the backup roller 80 was caused to press the intermediate transfer belt 40 by revolving the arm member 81. However, the revolving operation of the arm member 81 is not necessarily required, and as another example, the backup roller 80 can be fixed rotatably at a predetermined height.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-111487, filed May 29, 2014 and Japanese Patent Application No. 2015-088457, filed Apr. 23, 2015 which are hereby incorporated by reference herein in their entirety.

What is claimed is:

1. An image forming apparatus comprising:
an intermediate transfer belt;
a toner image forming portion configured to form a toner image on the intermediate transfer belt;
a biasing member configured to bias an extension roller on which the intermediate transfer belt is extended toward the intermediate transfer belt and applying tension to the intermediate transfer belt;
a support roller in contact with an inner side surface of the intermediate transfer belt, configured to support the intermediate transfer belt;
a rotator configured to form a nip portion by nipping the intermediate transfer belt with the support roller;
a power supply configured to apply voltage between the rotator and the support roller, and to transfer a toner image at the nip portion to a recording medium conveyed through the nip portion;
a guide portion, disposed upstream from the nip portion in a direction in which the recording medium is conveyed, configured to guide the recording medium to the nip portion; and
a press member arranged upstream and adjacent to the nip portion in a direction of rotation of the intermediate transfer belt from the nip portion, configured to elastically press an inner side surface of the intermediate transfer belt, a press force of the press member for the intermediate transfer belt being greater than the tension that the biasing member applies to the intermediate transfer belt.

2. The image forming apparatus according to claim 1, wherein
the press member is an elastic plate member supported in a cantilever having a fixed end portion disposed upstream in the direction of rotation of the intermediate transfer belt and a free end portion disposed downstream in the direction of rotation of the intermediate transfer belt and in contact with an inner side surface of the intermediate transfer belt to elastically press the intermediate transfer belt.

3. The image forming apparatus according to claim 2, wherein
the press force F by which the press member presses the intermediate transfer belt satisfies the following expression:
F=Z×E×b×h³/(4×L³)
where Z denotes an amount of deflection of the elastic plate member, E denotes a Young's module, b denotes a length of the elastic plate member along an axial direction of the support roller, h denotes a thickness of the elastic plate member, and L denotes a free length of the elastic plate member supported in a cantilever.

4. The image forming apparatus according to claim 1, wherein
the press member is an elastic plate member arranged along an axial direction with respect to the support roller with a tip side thereof facing the nip portion, having one surface on the tip side is in surface contact with an inner side surface of the intermediate transfer belt and bent in the form of a cantilever.

5. The image forming apparatus according to claim 4, further comprising:
a pair of frame members arranged in a width direction perpendicular to a direction of rotation of the intermediate transfer belt with the intermediate transfer belt interposed therebetween, for supporting the extension roller and the support roller; and
a cantilever support member arranged in parallel with the support roller and upstream in the direction of rotation of the intermediate transfer belt from the position in which the elastic plate member is in contact with the intermediate transfer belt, being supported by the pair of frame members and supporting the elastic plate member in a cantilever.

6. The image forming apparatus according to claim 5, further comprising:
an adjustment mechanism adjusting and fixing a support position with respect to the pair of frame members of the cantilever support member, the adjustment mechanism capable of adjusting a press force by which the elastic plate member elastically presses an inner side surface of the intermediate transfer belt by adjusting the support position.

7. The image forming apparatus according to claim 1, wherein
the press member is a press roller rotatably arranged in parallel with the support roller and in contact with the inner side surface of the intermediate transfer belt to elastically press the intermediate transfer belt.

8. The image forming apparatus according to claim 7, further comprising:
a pair of frame members arranged in a width direction perpendicular to the direction of rotation of the intermediate transfer belt with the intermediate transfer belt interposed therebetween, and supports the extension roller and the support roller;
an arm member having a center-side end section rotatably supported by the pair of frame members, and a revolving-side end section supporting the press roller in a rotatable manner; and
a spring member biasing the arm member and causing the press roller to be in contact with the inner side surface of the intermediate transfer belt to elastically press the intermediate transfer belt.

9. The image forming apparatus according to claim 1, wherein
the guide portion has a first guide member arranged on an outer circumference side of the intermediate transfer belt and restricting a behavior of the recording medium conveyed to the nip portion from moving away from the intermediate transfer belt, and a second guide member arranged between the intermediate transfer belt and the first guide member and restricting a behavior of the recording medium conveyed to the nip portion from moving toward the intermediate transfer belt.

10. The image forming apparatus according to claim 1, wherein
the rotator is a transfer belt conveying the recording medium,
the image forming apparatus further comprising:
a transfer roller nipping the intermediate transfer belt and the transfer belt with the support roller; and
a transfer belt extension roller stretching the transfer belt at least together with the transfer roller.
